(19) United States
(12) Patent Application Publication
(10) Pub. No.: US 2017/0174181 A1
(43) Pub. Date: Jun. 22, 2017

(54) GEARED MOTOR UNIT FOR WINDSCREEN WIPER

(71) Applicant: Valeo Systèmes d'Essuyage, Le Mesnil Saint Denis (FR)

(72) Inventors: Yannick Guibert, Chatellerault (FR); Anne Sanon, Guyancourt (FR); Veronique Autret, Ville D'avray (FR)

(73) Assignee: Valeo Systemes d'Essuyage, Le Mesnil Saint Denis (FR)

(21) Appl. No.: 15/381,803

(22) Filed: Dec. 16, 2016

(30) Foreign Application Priority Data
Dec. 18, 2015 (FR) 1562770

(51) Int. Cl. B60S 1/04; B60S 1/16; H02K 5/00; F16H 57/025; H02K 7/116; B60S 1/08; F16H 57/028

(52) U.S. Cl. CPC B60S 1/0444; B60S 1/08; B60S 1/166; F16H 57/028; F16H 57/025; H02K 7/116; H02K 5/00; B60S 1/0452; F16H 2057/02082

(57) ABSTRACT

The present invention relates to a geared motor unit (1) for a motor vehicle wiper system, the geared motor unit comprising:
an electric motor (3) housed in a casing (4),
a reduction gear mechanism (5) connected to the electric motor (3),
a mount (9)receiving the reduction gear mechanism (5),
a fixing plate (11) and/or a closure pate (110) intended to be fixed on the one hand to the mount (9) and on the other hand to a structural element of the vehicle,
   in which, out of the following elements:
the fixing pate (11),
the closure pate (110),
the mount (9), and
the casing (4),
   at least one is made of a laminated composite material (39) comprising at least two layers (C1, C2, C3) of material and of which at least one of the layers (C2) is made from a viscoelastic material.

The present invention relates to the field of windscreen wipers and more particularly of windscreen wiper geared motor units intended to drive the windscreen wipers.

Geared motor units comprise a motor, generally an electric motor, housed in a casing and reduction gearing comprising a gears mechanism connecting the rotation shaft of the motor to an output shaft of the geared motor unit to which the windscreen wiper arm is fixed. The gears mechanism is mounted in a housing in a mount on which the motor is fixed. The mount is made of metal and/or of plastic and affords protection to the mechanism of the reduction gear and allows load to be transmitted between the two shafts that make up the geared motor unit, and may possibly also be able to house a rod-crank mechanism for converting the rotational movement into a reciprocating movement. The mount is fixed to a structural element of the vehicle, generally via a mount fixing plate or closure plate via retaining screws.

One problem associated with geared motor units has to do with the vibration and noise they may produce. Indeed, acoustics are an essential factor in comfort in present day motor vehicles which means that it has become necessary to prevent the vibration and sound produced by a geared motor unit from being transmitted to the other elements of the vehicle and particularly the vehicle interior. For that, the geared motor unit needs to be mechanically and acoustically uncoupled from the rest of the vehicle so as to isolate the vibration and noise of the geared motor unit. One of the known solutions for overcoming this problem is to use damping pads positioned at the interface between the geared motor unit and the structure of the vehicle.

However, it may happen that the vibration reduction afforded by the damping pads is insufficient in comparison with the desired level of reduction. In addition, damping pads are unable to diminish the noise emitted by the geared motor unit.

In order to overcome these disadvantages at least in part, the present invention relates to a geared motor unit for a motor vehicle wiper system, the geared motor unit comprising an electric motor housed in a casing, a reduction gear mechanism connected to the electric motor, a mount receiving the reduction gear mechanism and a fixing plate and/or a closure plate intended to be fixed on the one hand to the mount and on the other hand to a structural element of the vehicle, in which, out of the following elements:

the fixing plate,
the closure plate,
the mount, and
the casing,
at least one is made of a laminated composite material comprising at least two layers of material and of which at least one of the layers is made from a viscoelastic material, namely a material that has a high damping coefficient over a certain frequency range.

One example of a laminated composite material is described in document FR2951991A1.

For preference, the laminated composite material comprises at least three layers of material.

The use of a fixing plate and/or of a closure plate and/or of a mount and/or of a casing comprising a layer made from a viscoelastic material makes it possible to achieve vibrational uncoupling between the geared motor unit and the rest of the vehicle.

According to another aspect of the present invention, the laminated composite material comprises a first and a second outer layer and at least one intermediate layer made of viscoelastic material.

The outer layers hold the layer of viscoelastic material in place and provide the fixing and/or closure plate with static and dynamic stiffness.

According to an additional aspect, the viscoelastic material has a damping coefficient tan δ greater than 0.1 at 200 Hz in a temperature range of between 20 and 80°C., for a loading of geared motor unit type, the two outer layers having a damping coefficient tan δ less than 0.1 for the same measurement conditions.

According to another aspect, the ratio between the thickness of the intermediate layer and the least thick of the outer layers will be between 0.03 and 0.6.

According to an additional aspect, the first and second outer layers have different thicknesses.

The use of layers of different thicknesses makes it possible to optimize the filtration of vibration in a broader frequency range.

According to an additional aspect, one of the outer layers is at least twice the thickness of the other.

According to another aspect, at least one of the layers is metallic.

The use of a metallic layer also makes it possible to filter out electromagnetic waves and improve the electromagnetic compatibility between the geared motor unit and the rest of the vehicle.

According to an additional aspect, at least one of the layers is made of steel or a steel/aluminium alloy.

According to an additional aspect, the fixing plate or the closure plate comprises at least one opening to allow the said fixing plate or the said closure plate to be fixed to a structural element of the motor vehicle.

The opening is, for example, of the hole, slot, semicircular, etc. type.

According to an additional aspect, the closure plate is fixed to the mount and closes a housing in the mount in which the reduction gear mechanism is placed. The closure plate may also provide acoustic sealing, for example via a seal placed between the mount and the closure plate.

According to an additional aspect, the geared motor unit also comprises a cover fixed to the mount to close the housing in the mount in which the reduction gear mechanism is placed, and in which the fixing plate is fixed to the mount or to the cover, the said cover comprising a laminated composite materiel at least one of the layers of which is made of a viscoelastic material.

Further features and advantages of the invention will become apparent from the following description, given by way of nonlimiting example, with reference to the attached drawings in which:

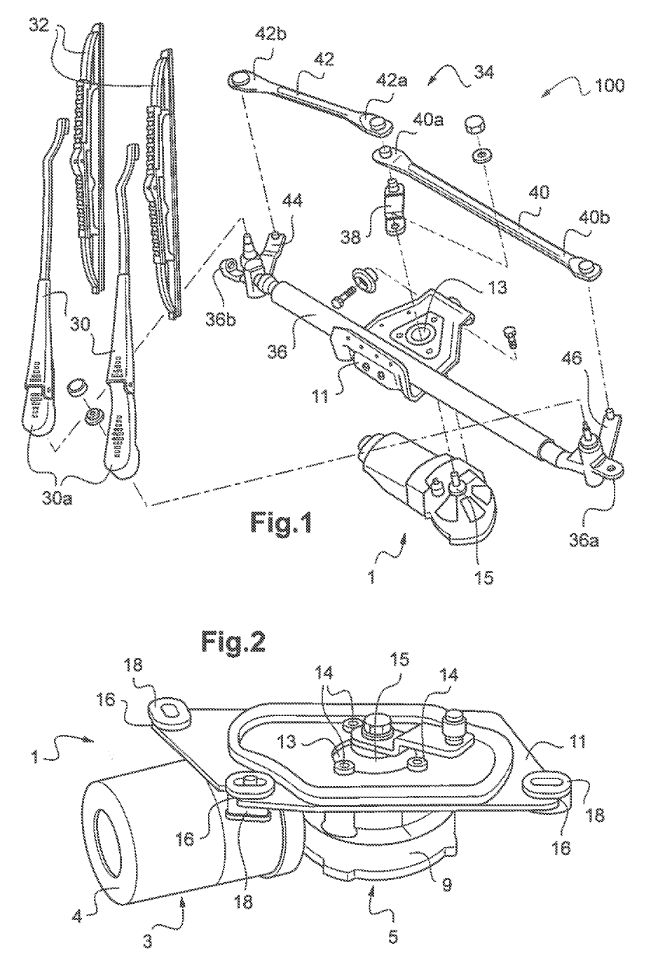

FIG. 1 depicts an exploded view of windscreen wiper equipment comprising a geared motor unit of a first type associated with a linkage system connecting the geared motor unit to the windscreen wiper arms;

FIG. 2 is a diagram of a first embodiment of a geared motor unit according to the first type;

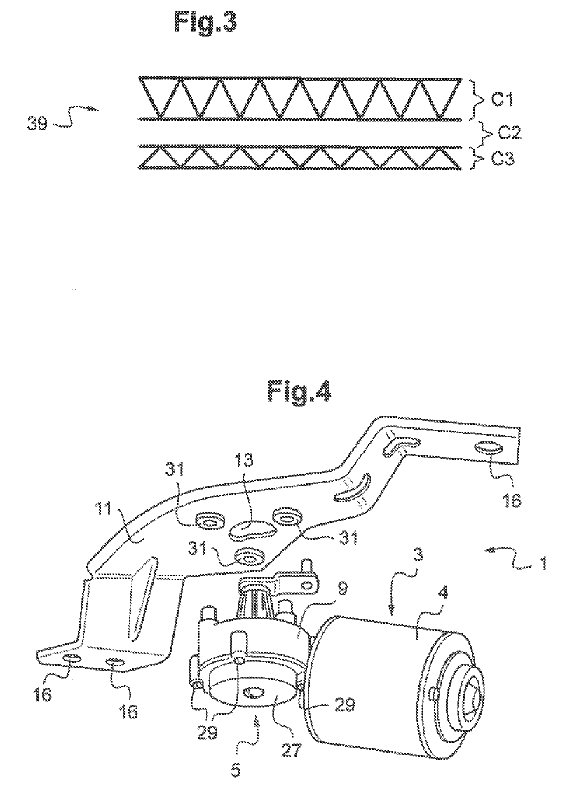

FIG. 3 is a cross-sectional diagram through the thickness of a laminated composite material according to one embodiment of the present invention;

FIG. 4 is a diagram of a second embodiment of a geared motor unit according to the first type;

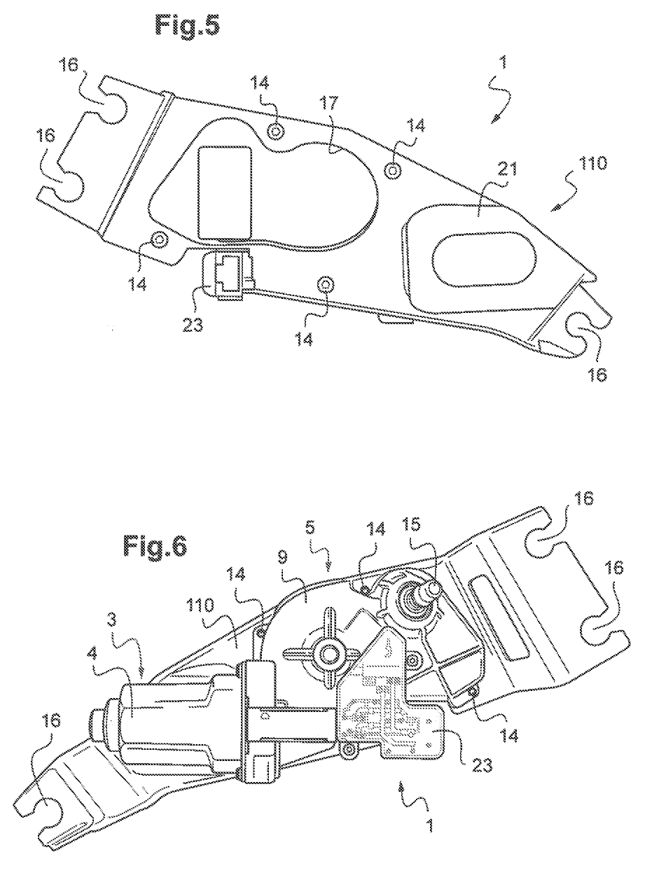

FIG. 5 is a diagram from a first side of a geared motor unit of a second type;

FIG. 6 is a diagram from a second side of a geared motor unit of a second type.

In all the figures, elements that have identical functions bear the same reference numerals.

In the remainder of the description, the term “opening”, notably associated with a plate, denotes a mechanical interface obtained by an absence of material such as, for example, a hole made in the plate or a slot, notably a semicircular slot, formed on an edge of the plate.

The following embodiments are examples. Although the description refers to one or more embodiments, that does not necessarily mean that each reference relates to the same embodiment or that the features apply only to that single embodiment. Simple features of various different embodiments may also be combined to make other embodiments.

FIG. 1 depicts an exploded view of a windscreen wiper system 100 comprising a geared motor unit 1, windscreen wiper arms 30 to the end of which windscreen wiper blades 32 are articulated and a linkage 34 that allows the movement of the output shaft 15 of the geared motor unit 1 to be transmitted to the windscreen wiper arms 30 to cause the windscreen wiper arms 30 to pivot. The linkage 34 for example connects the two windscreen wiper arms 30 situated on the windscreen at the front of the vehicle, to the geared motor unit 1 in order to drive the back and forth sweeping of the wiper blades 32 on the driver and passenger side. To do that, the linkage 34 comprises by way of elements: a support tube 36, a driving crank 38, two link rods 40, 42, one being a “master” link rod on the driver side and the other a “slave” link rod on the passenger side, and two levers 44, 46 mounted with the ability to rotate on the ends of the support tube 36.

A first end of the driving crank 38 is fixed to the output shaft 15 of the geared motor unit 1, for example as a “tight” fit. A second end of the driving crank 38 is articulated to the first ends 40a, 42a of the link rods 40, 42, for example via two “ball-cup” fittings. The two ends 40b, 42b of the link rods 40, 42 are articulated to first ends of a respective lever 44, 46, for example using a “ball-cup” fitting. The second ends of the levers 44, 46 are fixed to a respective head 30a of a wiper arm 3, for example by screw fastening.

In operation, rotation of the output shaft 15 of the geared motor unit 1 causes the driving crank 38 to pivot about the axis of the output shaft 15. The driving crank 38 drives the movement of the link rods 40, 42 which drives the pivoting of the levers 44, 46 about their respective second ends, to drive the pivoting of the wiper blades 32.

The geared motor unit 1 also comprises a fixing plate 11 configured to hold the geared motor unit 1 and possibly the support tube 36. The fixing plate 11 is intended to be fixed to a structural element of the vehicle. The support tube 36 may also be fixed to a structural element at its end fittings 36a and 36b. Alternatively, the fixing plate 11 may be fixed to the support tube 36, the geared motor unit 1 then being fixed to the fixing plate 11. In that case, the support tube 36 is fixed to a structural element of the vehicle, for example via its end fittings 36a and 36b.

FIG. 2 is a diagram of a geared motor unit 1 according to a first type similar to the geared motor unit 1 shown in FIG. 1 comprising an electric motor 3 housed in a casing 4, for example of cylindrical shape, and a reduction gear mechanism 5 connected to the electric motor 3. The geared motor unit 1 also comprises a mount 9 in which there is formed a housing to accept the reduction gear mechanism 5. The mount 9 and the casing 4 of the electric motor 3 are mechanically fixed to one another, for example using screws or welding or any means of fixing known to those skilled in the art.

For certain types of geared motor unit 1, for example in the case of rear windscreen wiper systems, the mount 9 may also accept an inbuilt rod-crank system.

The geared motor unit 1 also comprises a fixing plate 11 intended to be fixed to the mount 9 on the one hand and, on the other hand, to a structural element of the vehicle or an element that is fixed with respect to the structure of the vehicle. The fixing plate 11 is, for example, fixed to the mount 9 by screws 14, three of these in the case of FIG. 2. The fixing plate 11 may have shapes that vary according to the model of the geared motor unit 1 and to the shape of the vehicle structural element to which it is fixed, notably a flat rectangular shape in this particular instance. The fixing plate 11 may also comprise a central orifice 13 through which the output shaft 15 of the geared motor unit 1 extends.

The fixing plate 11 also comprises openings 16, three in this instance, to allow it to be fixed to a structural element of the vehicle. The means that fix the fixing plate 11 to the structural element of the vehicle comprise, for example, screws, three in this instance, which are inserted into the openings 16 in the fixing plate 11. The openings 16 will for example be situated at the periphery of the fixing plate 11 and may be produced in the form of holes or slots, for example of semicircular shape,

However, the location and number of these openings 16 may vary according to the shape of the fixing plate 11 and the shape of the structural element of the vehicle to which the fixing plate 11 is fixed.

The means that fix the fixing plate 11 to a structural element of the vehicle may also comprise damping pads 18 positioned at the interface between the fixing plate 11 and the structural element of the vehicle in order to filter vibration.

In order to improve the uncoupling between the inside of the geared motor unit 1 and the structure of the vehicle and reduce the spread of noise and vibration between the reduction gear mechanism 5 and the structure of the vehicle, at least one of the intermediate elements between the electric motor 3 and a structural element of the vehicle, which means to say at least one of the elements that are the casing 4 of the electric motor 3, the mount 9 and the fixing plate 11, comprises or is made up of a laminated composite material 39 comprising at least two layers at least one of the layers of which is made from a viscoelastic material, which means to say a material that has a high loss factor.

FIG. 3 depicts the various layers of a laminated composite material 39 according to an embodiment comprising three layers, two outer layers denoted C1 and C3, and an intermediate layer C2. The intermediate layer C2 is made from a viscoelastic material, which means to say from a material that has a loss coefficient tan δ greater than 0.1 at 200 Hz, for a temperature lying in a range from 20 to 80° C. and under vibrational stressing conditions of a wiper motor type. The loss coefficient, also referred to as the damping coefficient, is a measure of the ratio of the energy dissipated by damping to the elastic energy conserved. This viscoelastic material is, for example, an elastomer and the ratio between the thickness of the intermediate layer and that of the least thick outer layer is, for example, between 0.03 and 0.6.

The outer layers C1 and C3 are made from a material the dynamic and static stiffness of which will be far higher than that of the viscoelastic material, namely from a material that has a damping coefficient of less than 0.1 under the conditions described hereinabove, such as, for example a metal such as steel or a steel/aluminium alloy or a hard plastic. The role of the outer layers C1 and C3 is to break the impedance or dynamic stiffness with the intermediate layer C2 made of viscoelastic material which is sandwiched between the outer layers C1 and C3 thereby making it possible to filter a transmitted vibration and noise. The two outer layers C1 and C3 may be made from the same material or from different materials.

For preference, at least one of the layers of the laminated composite material 39 is metallic so as to form a barrier to electromagnetic waves and improve the electromagnetic compatibility between the electric motor 3 and/or the reduction gear mechanism 5 and the other elements of the vehicle.

Again for preference, if several layers of the laminated composite material 39 are made from the same material then their thicknesses are different, for example one of the outer layers C1, C3 has at least twice the thickness of the other, so as to optimize the uncoupling over the target frequency range for uncoupling between the geared motor unit and the structure of the vehicle and thus obtain low acoustic transparency of the element or elements of which the laminated composite material 30 is comprised within a given frequency range. This optimizing of the uncoupling makes it possible to reduce the transmission of noise through these elements. For example, if the two outer layers C1 and C3 are made of steel, their thicknesses will be different, for example 1 mm for the layer C1 and 2 mm for the layer C3.

The various materials of which the laminated composite material 39 is made and the thicknesses thereof may be chosen according to the frequencies for which a high degree of uncoupling is desired, for example the resonant frequency or frequencies of the geared motor unit 1.

The composition of the laminated composite material 39 used in one of the elements of the geared motor unit 1 is not restricted to the laminated composite material 39 shown in FIG. 3 but extends to cover any laminated composite material 39 comprising at least one layer made from a viscoelastic material and at least one rigid layer that gives the geared motor unit 1 rigidity when in use. The laminated composite material 39 may for example comprise five layers three of them being intermediate layers comprising two layers made of viscoelastic material separated by a third layer formed of a more rigid material, and two outer layers likewise formed from a more rigid material.

Specifically, and for preference, if several layers of viscoelastic material are used, they will be separated by a more rigid intermediate layer.

FIG. 4 is a diagram of a geared motor unit 1 of the same type as the geared motor unit 1 shown in FIGS. 1 and 2 but in which the fixing plate 11 is different and the openings 16 are produced in the form of holes. In addition, the geared motor unit 1 comprises a cover 27 (not visible in FIG. 1) that is fixed onto the mount 9, for example using fixing screws 29, three in this instance, to close the housing in the mount 9 that contains the reduction gear mechanism 5. The mount 9 and the cover 27 therefore form a box for the reduction gear mechanism 5. In this instance, the cover 27 may also comprise a laminated composite material 39 as described hereinabove. The other features are identical to the geared motor unit 1 of FIGS. 1 and 2.

The means of fixing the fixing plate 11 to a structural element of the vehicle also remain the same as before since the openings 16 in the form of holes, of which there are three in this instance, are intended to accept fixing screws and possibly damping pads 18.

In addition, FIG. 4 depicts the fixing orifices 31, three in this case, that allow the mount 9 to be fixed to the fixing plate 11. These fixing orifices 31 are arranged around the central orifice 13 intended to accept the output shaft 15 of the geared motor unit 1 and are intended to accept the fixing screws 14 depicted in FIG. 2.

FIGS. 5 and 6 depict a geared motor unit 1 according to a second type, comprising a closure plate 110 intended on the one hand to be fixed to the mount 9 in order to close the housing in which the reduction gear mechanism 5 is situated and, on the other hand, to be fixed to a structural element of the vehicle. Thus, the closure plate 110 replaces the fixing plate 11 and possibly the cover 27 of the first type of geared motor unit 1 introduced earlier.

FIG. 5 depicts a first face of the closure plate 110, corresponding to the external face, which means to say the opposite face to the reduction gear mechanism 5. The closure plate 110 may differ in shape according to the model of the geared motor unit 1 and according to the structural element of the vehicle to which it is fixed.

In FIG. 5, the closure plate comprises a first depression 17 corresponding to the location for the reduction gear mechanism 5, and a second depression 21 corresponding, to the location for fixing the electric motor 3.

The casing 4 of the electric motor 3 and the mount 9 containing the reduction gear mechanism ere better visible in FIG. 6 which shows a second face of the closure plate 110, corresponding to the internal face, which means to say the face against which the mount 9 will be fixed, the closure plate 110 thus closing off the housing in which the reduction gear mechanism 5 is situated.

The closure plate 110 is fixed to the mount 9 for example using screws 14, four of these in this instance. The geared motor unit 1 also comprises a connector 23 for making the electrical connection between the geared motor unit 1 and an electrical power supply of the vehicle (a connector is also present in the first type of geared motor unit but was not depicted in FIGS. 1, 2 and 4).

In order to allow the geared motor unit 1 to be fixed to a structural element of the vehicle, the closure plate 110 also comprises a fixing device that may potentially allow the fitting of damping pads, in this particular instance, this fixing device is similar to that of the fixing plate described earlier and is achieved using three openings 16 formed by slots at the ends of the closure plate 110. The location, shape and number of these openings 16 may vary according to the shape of the closure plate 110 and to the shape of the structural element of the vehicle to which it is fixed. Moreover, the openings 16 may also be produced in the form of holes since the fixing can also be achieved using screws.

In addition, in order to improve the uncoupling between the geared motor unit 1 and the structure of the vehicle and to reduce the spread of noise and vibration between the reduction gear mechanism 5 and the structure of the vehicle, the closure plate 110 may comprise a laminated composite material 39 as described hereinabove.

The use of a laminated composite material 39 for at least one of the intermediate elements between the electric motor 3 and the structure of the vehicle, particularly for the fixing plate 11 or the closure plate 110 which makes the connection between the geared motor unit 1 and the structure of the vehicle, thus makes it possible to improve the vibrational uncoupling between the geared motor unit 1 and the structure of the vehicle. The use of a laminated composite material 39 may be coupled with the use of damping pads 18.

Alternatively, if the uncoupling afforded by the laminated composite material 39 is sufficient and corresponds to the desired level of vibrational uncoupling, the fixing plate 11 or the closure plate 110, depending on the type of geared motor unit 1, may then be fixed directly to the structural element of the vehicle without the use of damping pads 18. In that case, it is the fixing plate 11 or the closure plate 110 which alone affords the mechanical uncoupling and provides the attenuation of the vibration. Dispensing with the damping pads 18 then makes it possible to simplify assembly and reduce the number of components needed for the geared motor unit 1, thereby simplifying the logistics associated with the components. The use of laminated composite material for the other elements of the geared motor unit 1, such as the casing 4 of the electric motor 3 or the mount 9, makes it possible not only to further improve the vibrational uncoupling but also to attenuate the transmission of the noises emitted by the electric motor 3 or the reduction gear mechanism 5.

Thus, the use, for at least one of the constituent elements of the geared motor unit 1, of a laminated composite material 39 of which at least one of the layers is made of a viscoelastic material makes it possible to create mechanical uncoupling that allows an attenuation of the vibration transmitted between the geared motor unit 1 and the structure of the vehicle thereby making it possible to improve the filtration of vibration performed by the damping pads 18 or possibly even making it possible to dispense with the damping pads 18. In addition, the use of such a material does not increase the complexity of the mounting of the geared motor unit 1 and can therefore be easily introduced into a mass-production run. The use of a laminated composite material 39 also makes it possible to reduce the acoustic transparency, which means to say increase the acoustic insulation, of the geared motor unit 1 and improve the electromagnetic compatibility when one of the layers of the laminated composite material is metallic.

1. A geared motor unit for a motor vehicle wiper system, the geared motor unit comprising:
an electric motor housed in a casing;
a reduction gear mechanism connected to the electric motor;
a mount receiving the reduction gear mechanism; and
a fixing plate and/or a closure plate configured to be fixed to the mount and to a structural element of the vehicle,
wherein, out of the the fixing plate, the closure plate, the mount, and the casing, at least one is made of a laminated composite material comprising at least two layers of material and of which at least one of the layers is made from a viscoelastic material.

2. The geared motor unit according to claim 1, in which the laminated composite material comprises a first and a second outer layer and at least one intermediate layer made of viscoelastic material.

3. The geared motor unit according to claim 2, in which the viscoelastic material has a damping coefficient tan δ greater than 0.1 at 200 Hz in a temperature range of between 20 and 80° C., the first and second outer layers having a damping coefficient tan δ less than 0.1 at 200 Hz in the temperature range of between 20 and 80° C.

4. The geared motor unit according to claim 2, in which the ratio between the thickness of the intermediate layer and the least thick of the outer layers is between 0.03 and 0.6.

5. The geared motor unit according to claim 2 4, in which the first and second outer layers have different thicknesses.

6. The geared motor unit according to claim 5, in which one of the outer layers is at least twice the thickness of the other.

7. The geared motor unit according to claim 1, in which at least one of the layers is metallic.

8. The geared motor unit according to claim 7, in which at least one of the layers is made of steel or a steel/aluminium alloy.

9. The geared motor unit according to claim 1, in which the fixing plate or the closure plate comprises at least one opening to allow the said fixing plate or the said closure plate to be fixed to a structural element of the motor vehicle.

10. The geared motor unit according to claim 1, in which the closure plate is fixed to the mount and closes a housing in the mount in which the reduction gear mechanism is placed.

11. The geared motor unit according to claim 1, further comprising a cover fixed to the mount to close the housing in the mount in which the reduction gear mechanism is placed, and in which the fixing plate is fixed to the mount or to the cover, the cover comprising a laminated composite material at least one of the layers of which is made of a viscoelastic material.
